(19) United States
(12) Patent Application Publication
(10) Pub. No.: US 2010/0104064 A1
(43) Pub. Date: Apr. 29, 2010

(54) SYSTEM AND METHOD FOR THREAT DETECTION

(75) Inventors: Scott Stephen Zelakiewicz, Niskayuna, NY (US); Ralph Thomas Hoctor, Saratoga Springs, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/256,755

(22) Filed: Oct. 23, 2008

(51) Int. Cl. G01N 23/04

(52) U.S. Cl. 378/57

(57) ABSTRACT

A system for threat detection is provided. The system includes an imaging detector configured to detect radiation originating from at least one source of radiation over a pre-determined period of time or distance traveled. The system also includes a processor coupled to the imaging detector. The processor is configured to backproject the radiation detected onto multiple points in world space via an image reconstruction technique. The processor is also configured to generate a first set of image pixels identifying a location of the source of radiation corresponding to each of the points in world space, wherein the first set of image pixels indicate presence of all possible sources of radiation. The processor is further configured to generate a second set of image pixels from the radiation backprojected, identifying only one or more potential sources of threat via a threat detection algorithm.

### STATEMENT REGARDING FEDERALLY SPONSORED RESEARCH OR DEVELOPMENT

This invention was made with Government support under contract HSHQDC-07-C-00092 awarded by the Department of Homeland Security. The Government has certain rights in this invention.

### BACKGROUND

The invention relates generally to security inspection systems, and more particularly, to inspection systems for detecting radiological threat objects.

Given the desire of terrorist organizations to obtain nuclear weapons or other radiological weapons such as “dirty” bombs, serious efforts are being made to assess nations' vulnerabilities and to enhance nations' security. Potential areas of vulnerability can include, for example, seaports, airports, urban areas, borders, stadiums, points of interest, and the like. In U.S. seaports, for example, an average of about 16,000 cargo containers arrive by ship every day, any one of which could be used to conceal fissile material or an assembled nuclear device. Furthermore, once in the country, the nuclear material could travel virtually anywhere in the country with little to no detection capability.

A currently prevailing model for addressing such threats associated with potentially reactive material could be characterized as a customs-based approach, where radiation detection systems are integrated into the existing customs infrastructure at ports and border crossings. Once the containers leave the customs area, additional screening methods are required to investigate potential threats once within the county's borders.

Several methods exist for detecting nuclear material once within the nation's borders. These systems largely consist of devices which can detect radiation but neither definitely locate the source or discriminate between naturally occurring sources of radiation and genuine threats. The devices include small pager-sized devices and larger Geiger counter based detectors. These devices rely on measuring a local increase in the detection of gamma-rays to determine the presence of radioactive material. Because they do not perform any imaging or energy discrimination, they often indicate false-positive threats potentially leading to ignoring true threats. To passively detect and locate radioactive material that could be used in potential terrorism threats domestically, several technologies have been considered. Attenuating collimators to achieve the radioactive localization suffer from low efficiencies and can have significant weight issues to attenuate high energy gamma-rays. Compton cameras can be used due to their localization abilities, but their inherent inefficiencies at low radiation energies, high cost, and high system complexity make them undesirable for such applications.

Systems for detecting radioactive material can employ coded aperture imaging. Coded aperture imaging provides a means for improving the spatial resolution, sensitivity, and signal-to-noise ratio (SNR) of images formed by x-ray or gamma ray radiation. In contrast to these other systems, for instance, the coded aperture camera is characterized by high sensitivity, while simultaneously achieving exceptional spatial resolution in the reconstructed image.

Sources of such high energy electromagnetic radiation (i.e., X-ray, gamma-ray) are generally imaged by coded aperture arrays onto a detector, which has detector elements, arranged in a pattern of rows and columns. Imaging techniques based on coded apertures have been successfully applied by the astrophysics community, and are now being developed for national security purposes.

When used to image distant sources from a moving vehicle, such coded aperture systems use backprojection or more elaborate backprojection-based reconstruction algorithms, to form the image. Backprojection, which is also known as “laminography”, is a well-known image formation technique used in computed tomography. The image formation approaches used in conjunction with coded aperture imagers mounted on moving platforms resemble those of “single-photon emission computed tomography” (SPECT), except that the axial imaging geometry is replaced by the geometry of “motion tomography”. (See A. Macovski, “Medical Imaging Systems”, Prentice Hall, 1983.). This prior-art imaging approach is also an example of the general approach of synthetic aperture imaging.

In addition to imaging approaches, which attempt to locate a radiation source in space, there are two classes of known techniques that attempt to use the energy spectrum of sensed radiation to determine the characteristics of the radiation source. We refer to all such methods as “threat detection”. Threat classification is an approach that uses statistical pattern recognition concepts to classify an observed energy spectrum as being a threat or a non-threat. Gamma spectroscopy based approaches try to pick out from the energy spectrum the spectral features of specific radioisotopes that are considered threats. Such threat detection techniques do not locate any detected threat in space; rather, they only determine whether the energy spectrum observed at a particular point in space contains features that indicate the presence of a threat.

Accordingly, there is a need for an improved threat detection system that can reliably detect threat material located anywhere in an examined region.

### BRIEF DESCRIPTION

In accordance with an embodiment of the invention, a system for threat detection is provided. The system includes an imaging detector configured to detect radiation originating from at least one source of radiation over a pre-determined period of time or distance traveled. The system also includes a processor coupled to the imaging detector. The processor is configured to backproject the radiation detected onto multiple points in world space via an image reconstruction technique. The processor is also configured to generate a first set of image pixels identifying a location of the source of radiation corresponding to each of the points in world space, wherein the first set of image pixels indicate presence of all possible sources of radiation. The processor is further configured to generate a second set of image pixels based upon the first set of image pixels identifying only one or more potential sources of threat via a threat detection algorithm.

In accordance with another embodiment of the invention, a method for providing a threat detection system is provided. The method includes providing an imaging detector configured to detect radiation originating from at least one source of radiation over a pre-determined period of time or distance traveled. The method also includes providing a processor coupled to the imaging detector. The processor is configured to backproject the radiation detected onto multiple points in world space via an image reconstruction technique. The processor is also configured to generate a first set of image pixels identifying a location of the source of radiation corresponding to each of the points in world space, wherein the first set of image pixels indicate presence of all possible sources of radiation. The processor is further configured to generate a second set of image pixels based upon the first set of image pixels identifying only one or more potential sources of threat via a threat detection algorithm.

In accordance with another embodiment of the invention, a method for threat detection is provided. The method includes detecting radiation originating from at least one source of radiation over a pre-determined period of time or distance traveled by an imaging detector. The method also includes backprojecting the radiation detected onto a plurality of points in world space via an image reconstruction technique. The method further includes generating a first set of image pixels identifying a location of the at least one source of radiation corresponding to each of the points in world space, the first set of image pixels indicating presence of all possible sources of radiation. The method also includes generating a second set of image pixels from the radiation backprojected, indicating presence of only one or more potential sources of threat via a threat detection algorithm.

These and other advantages and features will be more readily understood from the following detailed description of preferred embodiments of the invention that is provided in connection with the accompanying drawings.

### DRAWINGS

FIG. 1 is a diagrammatic illustration of an exemplary system for threat detection in accordance with an embodiment of the invention.

FIG. 2 is a schematic illustration of spectral backprojection of radiation detected by the system in FIG. 1.

FIG. 3 is an exemplary illustration of a threat image generated indicating presence of uranium 238.

FIG. 4 is an exemplary illustration of a threat image generated indicating presence of potassium 40.

FIG. 5 is an exemplary illustration of a threat image generated indicating presence of thorium 232.

FIG. 6 is a flow chart representing steps in a method for providing a threat detection system in accordance with an embodiment of the invention.

FIG. 7 is a flow chart representing steps in a method for threat detection in accordance with an embodiment of the invention.

### DETAILED DESCRIPTION

As discussed in detail below, embodiments of the invention include a system and method for threat detection. The system and method include a combination of an image reconstruction technique with a threat detection algorithm to indicate presence of a threat source or radioactive isotopes excluding naturally occurring radiological material and isotopes applicable to medicine and industry.

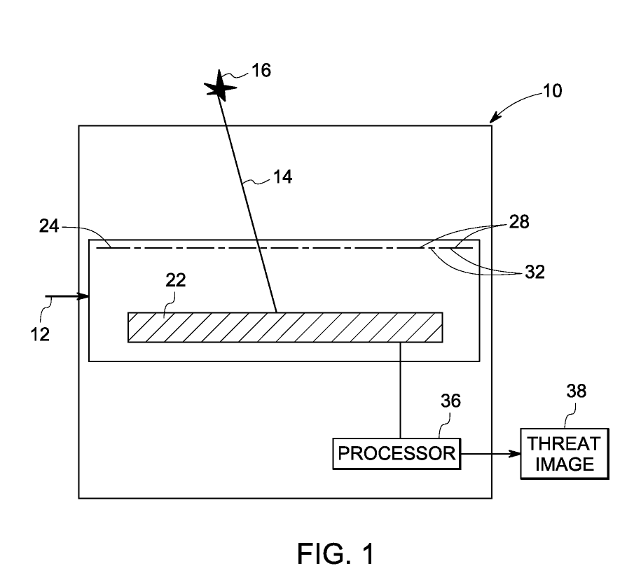

FIG. 1 is a diagrammatic illustration of an exemplary system 10 for threat detection. The system 10 includes an imaging detector 12 configured to detect radiation 14 originating from at least one source 16 of radiation over a pre-determined period of time or distance traveled by the detector. In the illustrated embodiment, the imaging detector 12 is a coded aperture detector. Another non-limiting example of the imaging detector 12 is a Compton camera. The imaging detector 12 comprises a position-sensitive detector (PSD) 22 and a coded aperture mask 24 disposed between the PSD 22 and the radiation source 16. In an exemplary embodiment, the PSD 22 is an Anger gamma camera. Further, the imaging detector 12 may be mounted on a moving platform, such as a truck, to assist in the image formation through the technique of a synthetic aperture. The radiation source 16 emits radiation 14, such as, but not limited to, X-ray and/or gamma-ray radiation that is modulated by the coded aperture mask 24 and impinges upon the PSD 22. The mask 24 can generally be made of an attenuating material. As used herein, “attenuating material” is used to generally define any material that reduces the intensity of a collection of x-rays or gamma ray. Exemplary attenuating materials can include tungsten, lead, linotype, and the like. Additionally, the attenuating material could itself be a material that is capable of detecting the incident radiation, such as, for example, a scintillator or a direct conversion semiconductor. The mask 24 generally comprises multiple open transparent regions 28 and closed regions 32 that are attenuating to the radiation 14 emitted by the source 16. In an exemplary embodiment, the closed attenuating regions 32 can be opaque to the incident radiation. Multiple patterns for the mask could be chosen and its choice is well know to those versed in the field. The mask 24 casts a shadow, patterned with the open 28 and closed 32 regions, on the PSD 22. The shadow can shift position depending on the location of the source 16. In one embodiment, the radiation source 16 may be moving and the imaging detector 12 may be stationary. In an alternative embodiment, the radiation source 16 may be stationary and the imaging detector 12 may be mobile. In yet another embodiment, both the radiation source 16 and the imaging detector 12 may be moving. In yet another embodiment, the imaging detector 12 and the radiation source 16 may both be stationary.

A processor 36 is coupled to the imaging detector 12. The processor 36 is configured to output a threat image 38 indicative of presence of an actual threat source. In operation, the processor 36 employs a combination of an image reconstruction technique that preserves the energy information of the radiation 14 and a threat detection algorithm to generate the threat image. Firstly, the processor 36 backprojects the radiation 14 that is detected onto multiple points in world space including energy information. A first set of image pixels is generated identifying location of the radiation source 16 for each of multiple mapped points in world space. The image pixels may be constructed based on all energies detected or a subset of the possible energies. The first set of image pixels indicates the presence of many possible types of radiation sources. It should be noted that image reconstruction techniques, other than backprojection, as discussed herein, may be employed. Secondly, a second set of image pixels, also referred to as a ‘threat image’ 38, is generated from the backprojection data identifying only one or more potential sources of threat via a threat detection algorithm. In an exemplary embodiment, a threat detection algorithm developed by Pacific Northwest National Laboratory (PNNL) for the identification of potential threat with low signal statistics (i.e. relatively few detected gamma rays) may be employed. Further details of a suitable threat detection algorithm may be obtained in a publication entitled “Examination of Count-Starved Gamma Spectra Using the Method of Spectral Comparison Ratios”, published in August 2007 in IEEE Transactions on Nuclear Science, Vol. 54, No.4, the entirety of which is hereby incorporated by reference herein. An alternative threat detection algorithm that would require significantly higher statistics is known as peak-fitting. Peak-fitting algorithms are a general class of techniques that rely on locating the peaks in an energy spectrum to identify isotopes and are well known in the field. In other embodiments, other methods of isotope identification may be employed that would either identify a specific isotope or narrow the possibility to a class of isotopes.

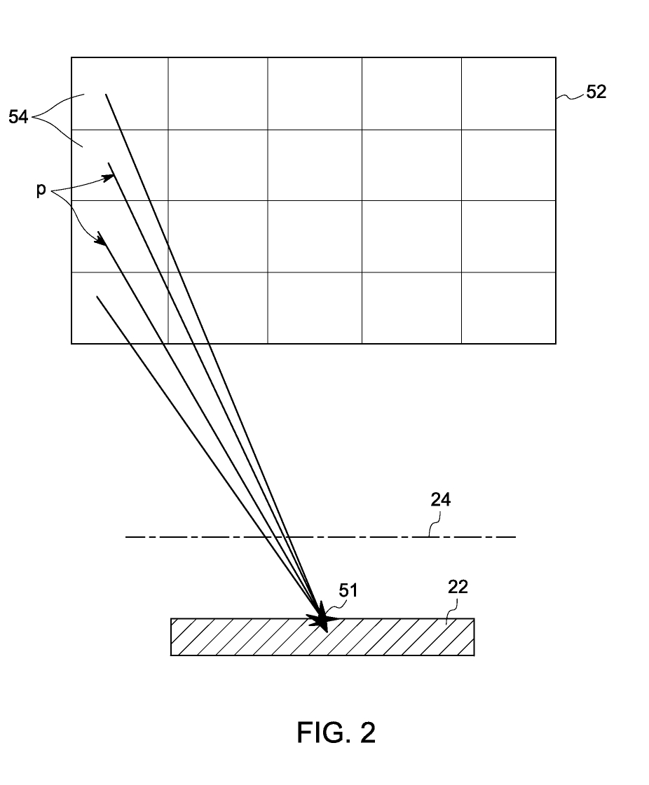

FIG. 2 is a schematic illustration of spectral backprojection of the detected radiation 51 onto world space 52. The detected radiation 51 on the PSD 22 (FIG. 1) is back projected through the mask 24 onto multiple pixels 54 in world space 52. A probability denoted by ‘p’ that the detected radiation 14 originated from a particular pixel is computed based on attenuating properties of the mask 24. This probability will be used as a weighting value when adding the detected radiation to the spectrum associated with a specific pixel 54. Further, a spectrum referred to as the ‘pixel spectrum’ is obtained for each pixel 54 in world space 52. For each energy and world space pixel location, the probability p for each of the detected radiation 51 is summed and recorded. A collection of all such sums for different energies at each pixel is the pixel spectrum. In this description and the associated figure a 2-dimension reconstruction space is depicted but the technique could be extend to 3-dimensions in an analogous manner. Additionally this describes a backprojection technique to generate the pixel spectrum. Other techniques are possible including those that are traditionally used to enhance contrast in a standard image.

After the pixel spectrum is generated for each location in the world space, the threat identification algorithm is then applied to these locations. Common in these algorithms is some need for background spectrum estimation, the spectrum due to background radiation including naturally occurring radiological materials (NORM) that would be present if no source was present. The background spectrum can be estimated in several ways including taking the mean of all the pixel spectra in the field of view, a historical background spectrum measured previously or an adaptive estimate that attempts to predict the background spectrum based on measurements prior to the current measurement.

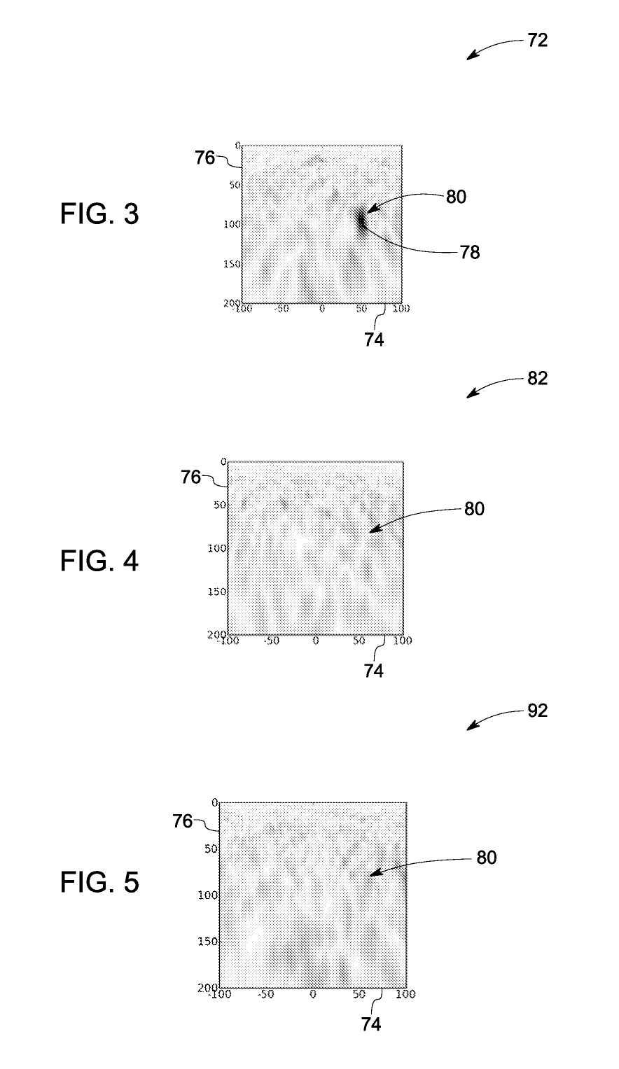

FIGS. 3-5 are exemplary illustrations of threat images 72, 82, and 92 obtained in a scenario wherein, uranium (U) 238, potassium (K) 40, and thorium (Th) 232 were disposed at co-ordinates (50, 100) in world space respectively. The X-axis 74 represents world space coordinates in a horizontal direction and Y-axis 76 represents world space coordinates along a perpendicular direction. For these illustrations, the detector system is moving parallel to the x-axis at y=0. The threat detection algorithm of PNNL referenced earlier was used and was designed to ignore K40 and Th232. As illustrated in FIG. 3, a dark spot 78 appears at location (50, 100) referenced by numeral 80 indicating presence of a threat source. Similarly, in FIGS. 4 and 5, absence of any feature at location 80 indicates absence of any threat source. It should be noted that in a conventional image projection technique to project images, features would be present indicating a threat. Thus, the threat detection algorithm eliminates triggering of false threat alarms.

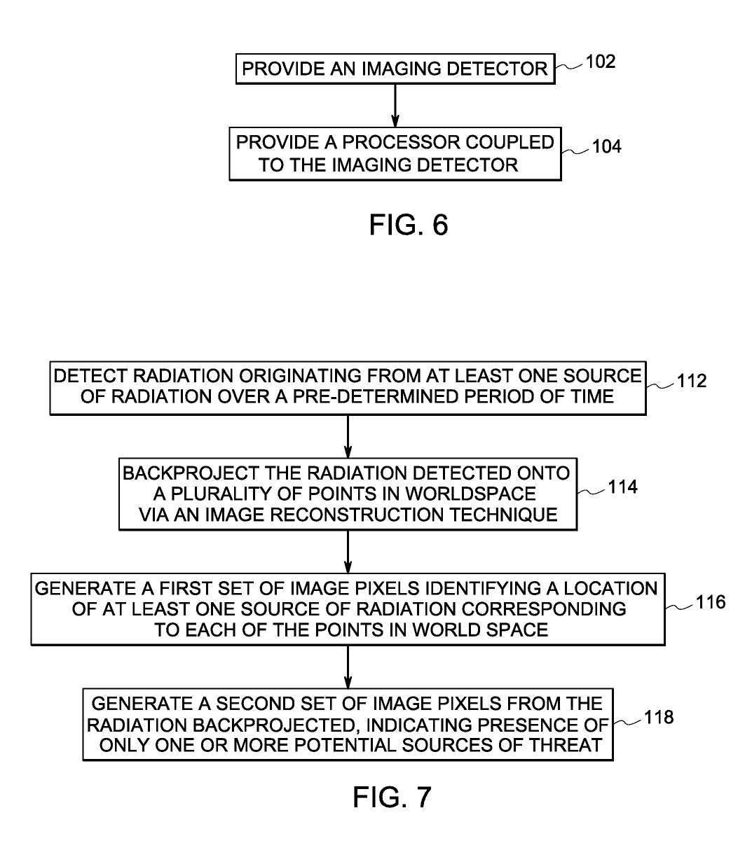

FIG. 6 is a flow chart representing steps in a method for providing a threat detection system. The method includes providing an imaging detector configured to detect radiation originating from at least one source of radiation over a pre-determined period of time or distance traveled by an imaging detector in step 102. In one embodiment, the imaging detector provided is a coded aperture system. In an alternative embodiment, the imaging detector is a Compton camera. Additionally the detector could be stationary or moving. A processor coupled to the imaging detector is provided in step 104. The processor is configured to backproject the radiation detected onto a plurality of points in world space via an image reconstruction technique. The processor is also configured to generate a first set of image pixels identifying a location of the source of radiation corresponding to each of the points in world space, wherein the first set of image pixels indicate presence of all possible sources of radiation. A second set of image pixels are further generated identifying only one or more potential sources of threat via a threat detection algorithm. In a particular embodiment, the threat detection algorithm ignores naturally occurring radiological material, and isotopes applicable to medicine and industry. In a particular embodiment, a background spectrum is determined in whole or part from either the second set of image pixels or predetermined values.

FIG. 7 is a flow chart representing steps in a method for threat detection. The method includes detecting radiation originating from at least one source of radiation over a pre-determined period of time or distance traveled by an imaging detector in step 112. The radiation detected is backprojected onto multiple points in world space via an image reconstruction technique in step 114. A first set of image pixels identifying a location of the source of radiation corresponding to each of the points in world space is generated in step 116. The first set of image pixels indicates presence of all possible sources of radiation. A second set of image pixels indicating presence of only one or more potential sources of threats is generated via a threat detection algorithm in step 118. The background spectrum used in the threat detection algorithm could be derived from the pixel spectra data or by other means.

The various embodiments of a system and method for threat detection described above thus provide a way to achieve a convenient and efficient identification of threat sources for security applications. The technique allows for a reduction in number of false positives that would otherwise become a nuisance to a user. Further, the system and technique allows for cost effective security means.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a Compton camera with respect to one embodiment can be adapted for use with a backprojection image reconstruction technique described with respect to another. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for threat detection comprising:
an imaging detector configured to detect radiation originating from at least one source of radiation over a pre-determined period of time or distance traveled; and
a processor coupled to the imaging detector, the processor configured to:
backproject the radiation detected onto a plurality of points in world space via an image reconstruction technique;
generate a first set of image pixels identifying a location of the source of radiation corresponding to each of the points in world space, the first set of image pixels indicating presence of all possible sources of radiation; and
generate a second set of image pixels from the radiation backprojected, identifying only one or more potential sources of threat via a threat detection algorithm.

2. The system of claim 1, wherein the imaging detector comprises a coded aperture system.

3. The system of claim 1, wherein the imaging detector comprises a Compton camera.

4. The system of claim 1, wherein the image reconstruction algorithm comprises back projection.

5. The system of claim 1, wherein the threat detection algorithm is configured to ignore naturally occurring radiological material, and isotopes applicable to medicine and industry.

6. The system of claim 1, wherein the imaging detector and the at least one source of radiation are moving relative to each other.

7. The system of claim 1, wherein a background spectrum is determined in whole or in part from either the second set of image pixels or predetermined values.

8. A method for providing a threat detection system comprising:
providing an imaging detector configured to detect radiation originating from at least one source of radiation over a pre-determined period of time or distance traveled; and
providing a processor coupled to the imaging detector, the processor configured to:
backproject the radiation detected onto a plurality of points in world space via an image reconstruction technique;
generate a first set of image pixels identifying a location of the source of radiation corresponding to each of the points in world space, the first set of image pixels indicating presence of all possible sources of radiation; and
generate a second set of image pixels from the radiation backprojected, identifying only one or more potential sources of threat via a threat detection algorithm.

9. The method of claim 8, wherein providing an imaging detector comprises providing a coded aperture system.

10. The method of claim 8, wherein providing an imaging detector comprises providing a Compton camera.

11. The method of claim 8, wherein the threat detection algorithm is configured to ignore naturally occurring radiological material, and isotopes applicable to medicine and industry.

12. The method of claim 8, further comprising determining a background spectrum in whole or in part from either the second set of image pixels or predetermined values.

13. A method for threat detection comprising:
detecting radiation originating from at least one source of radiation over a pre-determined period of time or distance traveled by an imaging detector;
backprojecting the radiation detected onto a plurality of points in world space via an image reconstruction technique;
generating a first set of image pixels identifying a location of at least one source of radiation corresponding to each of the points in world space, the first set of image pixels indicating presence of all possible sources of radiation; and
generating a second set of image pixels from the radiation backprojected, indicating presence of only one or more potential sources of threat via a threat detection algorithm.

14. The method of claim 13, wherein said detecting radiation comprises detecting via a coded aperture system.

15. The method of claim 13, wherein said detecting radiation comprises detecting via a Compton camera.

16. The method of claim 13, wherein said generating a first set of image pixels comprises generating via an image reconstruction technique.

17. The method of claim 13, further comprising determining a background spectrum in whole or in part from either the second set of image pixels or predetermined values.
